(19) United States
(12) Patent Application Publication
(10) Pub. No.: US 2007/0011052 A1
(43) Pub. Date: Jan. 11, 2007

(54) Method and apparatus for joint pricing and resource allocation under service-level agreement

(76) Inventors: Tieming Liu, Cambridge, MA (US); Zhen Liu, Tarrytown, NY (US); Laura Wynter, Chappaqua, NY (US)

Correspondence Address: KEUSEY, TUTUNJIAN & BITETTO, P.C., 20 CROSSWAYS PARK NORTH, SUITE 210, WOOBURY, NY, 11797, US

(21) Appl. No.: 11/147,628

(22) Filed: Jun. 8, 2005

(51) Int. Cl. G06Q 20/00

(52) U.S. Cl. 705/20

(57) ABSTRACT

There are provided an apparatus, a method, and a computer program product for joint determination of price and resource allocation. The apparatus includes a price and resource allocation determination device for jointly determining a price and a resource allocation for a given item or service offered for use or sale by a given e-retailer to optimize a pre-specified objective for the given e-retailer.

### BACKGROUND

1. Technical Field

The present invention relates generally to commerce and, more particularly, to a method and apparatus for joint pricing and resource allocation under a Service-Level Agreement (SLA).

2. Description of the Related Art

Combining pricing, and in particular, yield management-style pricing and service-level definition (that is, the terms to offer within an SLA (service-level agreement)) with the resource allocation and scheduling function has the benefit of an improved allocation, with respect to the revenue that it is expected to generate. Yield management is the paradigm that seeks to maximize revenue gain from a fixed and limited capacity by offering the “right price” for the “right service”. This means offering a spectrum of prices and service quality levels so as to maximize user differentiation. In so doing, yield management has the added benefit of smoothing demand through targeted price and service-level offerings, when varied according to periods of peak and off-peak use.

Yield management, sometimes referred to as “revenue management,” has been used to price airline seats since the 1980s. More recently, hotel chains and car rental companies have applied these principles to pricing their capacity of rooms and vehicles, respectively. In U.S. patent application Ser. No. 10/718,210, filed on Nov. 20, 2003, the disclosure of which is incorporated by reference herein and is commonly assigned to the assignee herein, a method is disclosed that determines a yield management pricing and service-level offering policy for a given on demand computing center capacity. In U.S. patent application Ser. No. 10/987,748, filed on Nov. 12, 2004, the disclosure of which is incorporated by reference herein and is commonly assigned to the assignee herein, it is demonstrated how yield management algorithms can be used in an on demand service within an infrastructure running legacy systems. However, these patents do not provide resource allocation information. It is assumed in those patents that the resource allocation and scheduling are done independently from the yield management pricing and service-level offering definition. For example, the results of running the yield management algorithms, that is, the prices and service level offering definitions, could be provided as input to an SLA-based resource allocation algorithm, such as the one disclosed in U.S. patent application Ser. No. 09/832,438, filed on Apr. 10, 2001, the disclosure of which is incorporated by reference herein and is commonly assigned to the assignee herein.

However, without then rerunning the yield management model based on the new resource allocation/scheduling capacities, and then returning once again to the scheduling algorithm with the new yield management results, and so on, the overall price/service offering definition/resource allocation need not be anywhere near optimal in terms of provider revenue.

### SUMMARY

These and other drawbacks and disadvantages of the prior art are addressed by the present invention, which is directed to a method and apparatus for joint pricing and resource allocation under a Service-Level Agreement (SLA).

The present invention may be implemented, e.g., as an apparatus, a method, and a computer program product.

According to an aspect of the present invention, there is provided an apparatus for joint determination of price and resource allocation. The apparatus includes a price and resource allocation determination device for jointly determining a price and a resource allocation for a given item or service offered for use or sale by a given e-retailer to optimize a pre-specified objective for the given e-retailer.

These and other objects, features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating an exemplary client-server environment in which the present invention may be employed, in accordance with the principles of the present invention;

FIG. 2 is a block diagram illustrating an exemplary computer processing system to which the present invention may be applied, in accordance with the principles of the present invention;

FIG. 3 is a flow diagram illustrating an exemplary market competition based method for determining a price and capacity of an item offered for sale by a plurality of e-retailers, in accordance with the principles of the present invention;

FIG. 4 is a graph illustrating an example of a demand model, in accordance with the principles of the present invention;

FIG. 5 is a graph illustrating a variation in the user choice probabilities as the degree of perfect information changes, in accordance with the principles of the present invention.

These and other aspects, features and advantages of the present invention will become apparent from the following detailed description of exemplary embodiments, which is to be read in connection with the accompanying drawings.

### DETAILED DESCRIPTION OF PREFFERED EMBODIMENTS

The present invention is directed to a method and apparatus for joint pricing and resource allocation under a Service-Level Agreement (SLA).

Advantageously, a method-and apparatus are provided for jointly determining the resource allocation/scheduling of transactions as well as the optimal prices and promised service levels. The resource allocation/scheduling of transactions or other types of information technology jobs may correspond to an on demand computing center and/or other entity such as, e.g., software as a service environment. Incorporating the resource allocation and scheduling functionalities into the yield management model provides a much tighter link between resources and SLA definition than are available through any other means.

Advantageously, we combine, in a single formulation, the pricing and service-level-offering definition functionality of yield management with the resource allocation and scheduling function to provide a revenue-maximizing solution for the service provider. Using methods for these two aspects of an on demand infrastructure independently ignores the strong correlation between the two sets of decisions, and inasmuch neglects an important source of revenue improvement. While it is technically feasible to alternately run one process and then the other process, in turn adding the new results of one to the other, and so on, this approach need not converge to a good final solution. Furthermore, it is not able to provide optimal “stopping times” for when the provider should switch from one price/service-level-offering for some user class(es) to a new one.

Advantageously, the present provides a potentially much more profitable solution, in addition to being readily implemented. The calculation of some minimal number of stopping times, in which the provider should switch price/SLA terms and scheduling parameters, means less disruption to the system, compared with obtaining new price/SLA terms/scheduling parameters each time two separate algorithms are run. Only a single, combined model such as that described herein could offer this stability of the solution and hence minimal disruption, since it can be used over a time horizon of multiple time periods. For example, the time horizon may be the 24 hours (periods) in each day. These and other time periods including varying time periods from one period to another period may also be employed in accordance with the present invention, while maintaining the scope of the present invention.

It is to be appreciated that the present invention differs from the prior art such as, e.g., that disclosed with respect to the above-mentioned U.S. patent applications Ser. Nos. 10/718,210 and 10/987,748, as the prior art approaches do not permit inclusion of the resource allocation and scheduling function.

It should be understood that the elements shown in the Figures may be implemented in various forms of hardware, software or combinations thereof. Preferably, these elements are implemented in software on one or more appropriately programmed general-purpose digital computers having a processor and memory and input/output interfaces.

It is to be appreciated that as used herein, the phrase “at least one”, when used to refer to more than one object (e.g., at least one of A and B), refers to at least the following: at least one of A, or at least one of B, or at least one of A and at least one of B. Further, it is to be appreciated that, as used herein, the phrase “jointly determined” refers to a method that computes more than one parameter while taking into account the dependencies between the two or more parameters that are computed. Moreover, it is to be appreciated that, as used herein, the term “item” refers to a good, a service, or a combination thereof.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

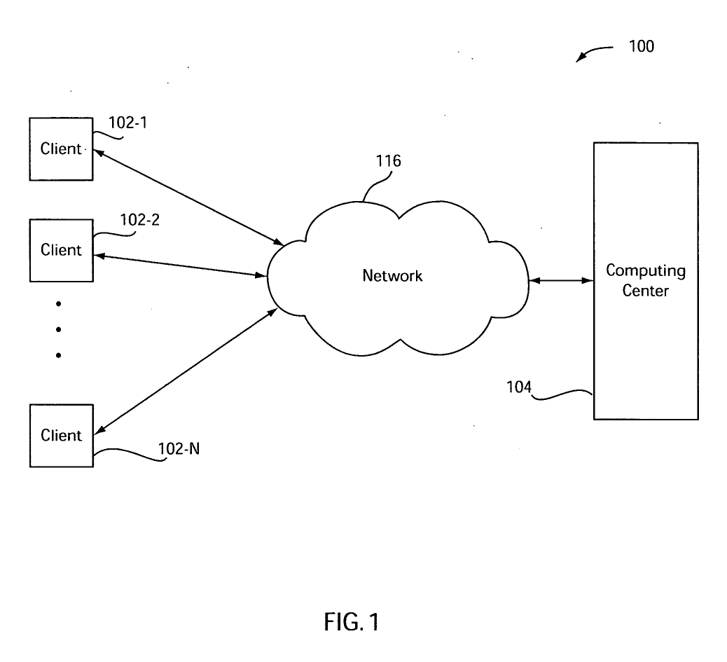

Turning to FIG. 1, an exemplary client-server environment in which the present invention may be employed is indicated generally by the reference numeral 100.

The client-server environment 100 includes a plurality of clients 102-1, 102-2, . . . , 102-N. Each of the plurality of clients is capable of connecting to a computing center 104 via a network 116.

Each of the plurality of clients 102-1 through 102-N and the computing center 104 may be considered to include at least one computer processing system. Of course, the computing center 104 is presumed to have the resources capable of interfacing with and providing pre-specified support and/or information to one or more of the plurality of clients.

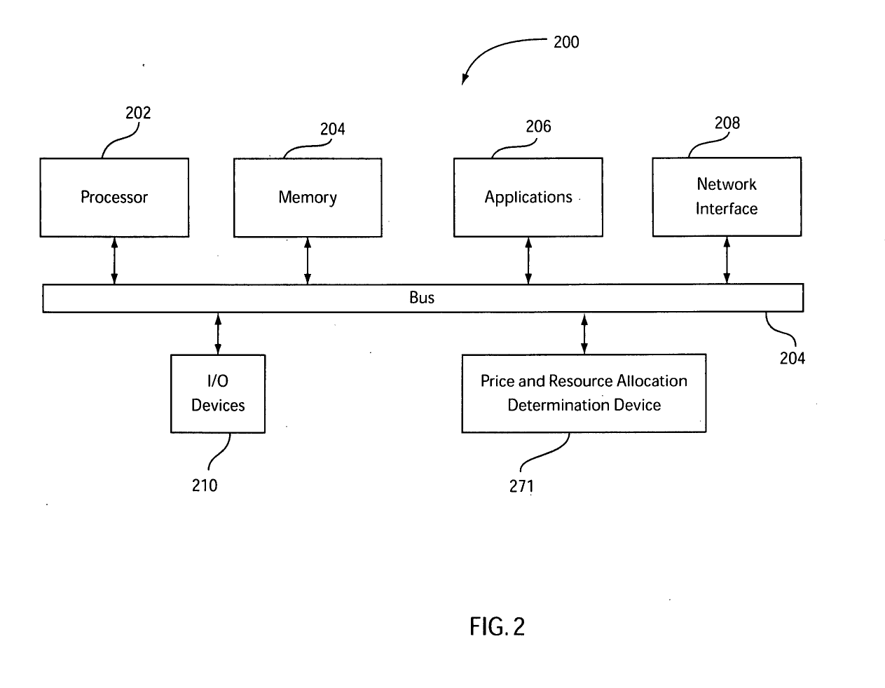

Turning to FIG. 2, an exemplary computer processing system to which the present invention may be applied is indicated generally by the reference numeral 200.

The computer processing system 200 includes one or more processors (hereinafter “processor”) 202, one or more memory devices (hereinafter “memory”) 204, applications 206, and one or more network interfaces (hereinafter “network interface”) 208. The memory 204 may include, but is not limited to, magnetic, optical, disk, RAM, ROM, cache, and so forth. The applications 206 include one or more operating systems and one or more corresponding applications. The network interface 208 may include means and/or structure to interface with wired and/or wireless networks.

The preceding elements of the computer processing system 200 may be found in any of the computing center 104 and the plurality of clients 102-1 through 102-N.

Advantageously, the following elements may also be found in the computing center 104: a price and resource allocation determination device 271.

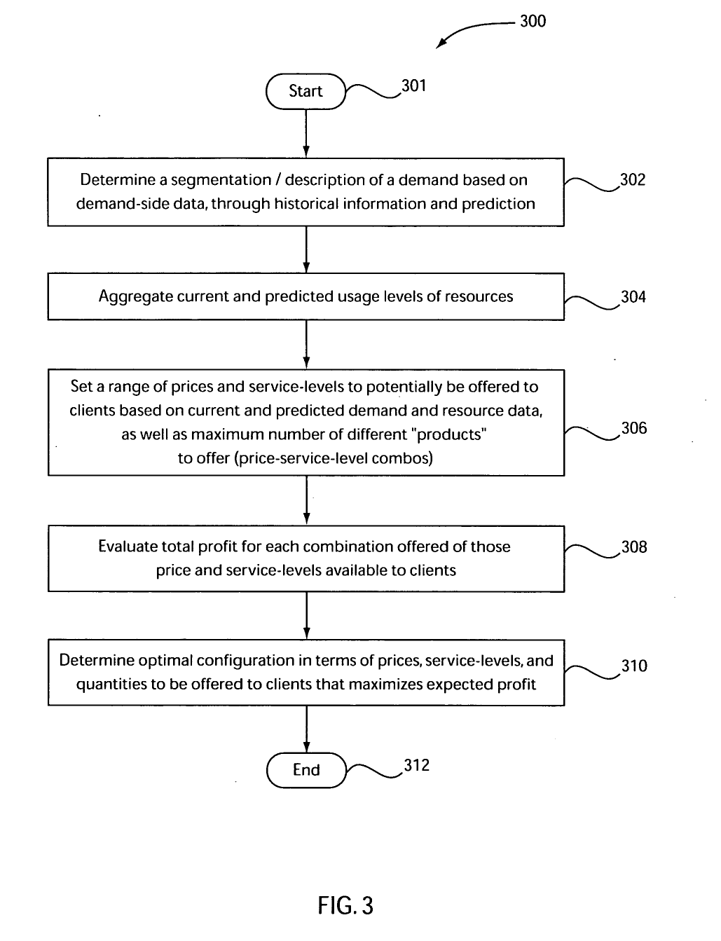

Turning to FIG. 3, an exemplary method for jointly determining price and resource allocation of an item offered for sale (hereinafter “item for sale” for short) by a plurality of e-retailers is indicated generally by the reference numeral 300.

A start box 301 passes control to a function block 302. The function block 302 determines a segmentation/description of a demand based on demand-side data through historical information and future prediction, and passes control to a function block 304. The function block 304 aggregates current and predicted usage levels of resources, and passes control to a function block 306. The function block 305 sets a range of prices and service levels to potentially be offered to clients based on current and predicted demand and resource data, as well as a maximum number of different “products” to offer (price-service-level combinations), and passes control to a function block 308. The function block 308 evaluates the total profit for each combination offered of those price and service-levels available to clients, and passes control to a function block 310. The function block 310 determines the optimal configuration in terms of prices, service-levels, and quantities to be offered to clients that maximizes expected profit, and passes control to an end block 312.

We assume a business epoch, which may be a day or a period less than or greater than a day, is separated into N equal-length time periods, t=1 . . . N. Demand for computing and software services is divided into J demand classes, j=1 . . . J. Transactions, or jobs, are submitted by each demand class at the start of each period. A demand class is defined so that transactions in the same class share the same features. For example, such features may include but are not limited to the same workload per transaction, identical sensitivities to price, the same preference for higher or lower quality of service (QoS), or the same degree of propensity (or not) for waiting for service.

That is, users may wait until a later period to have their transactions processed; the motivation from the user's point of view is to obtain a lower price or higher quality of service (QoS). Consequently, we denote by t the period when a transaction is submitted, and by s the period when that request is actually processed.

Demand for service is characterized by two input parameters, the arrival rate of transactions, or jobs, tau(j,t) from demand class j at period t, and the is the average workload per transaction in class j, w(j).

In addition to the demand classes, we assume that the service provider has the possibility of offering up to K service classes, k=1 . . . K. All transactions in the same service class during the same time period experience the same level of service.

For the purpose of illustration, we define the promised level of service by a bound on the delay experienced by the transaction; however, promised level of service may take any number of forms and may involve any number of metrics, of which delay is only one example. For instance, if, for some demand class, k, the shortest sojourn time of one unit of workload is T0(k), then the promised sojourn time of a transaction with workload w in service class k at period s should be bounded from above, with a probability alpha(k,s), by z(k,s)*w*T0(k). The variable, z(k,s), which is greater than 1, is thus the promised bound on the delay rate of class k at period s.

The objective of the model is to determine, for the service provider, the optimal prices, {r(k,s)} and service levels, {z(k,s)}, for each service class and each time period, that should be offered to its customers over the time horizon, T, so as to maximize its profits.

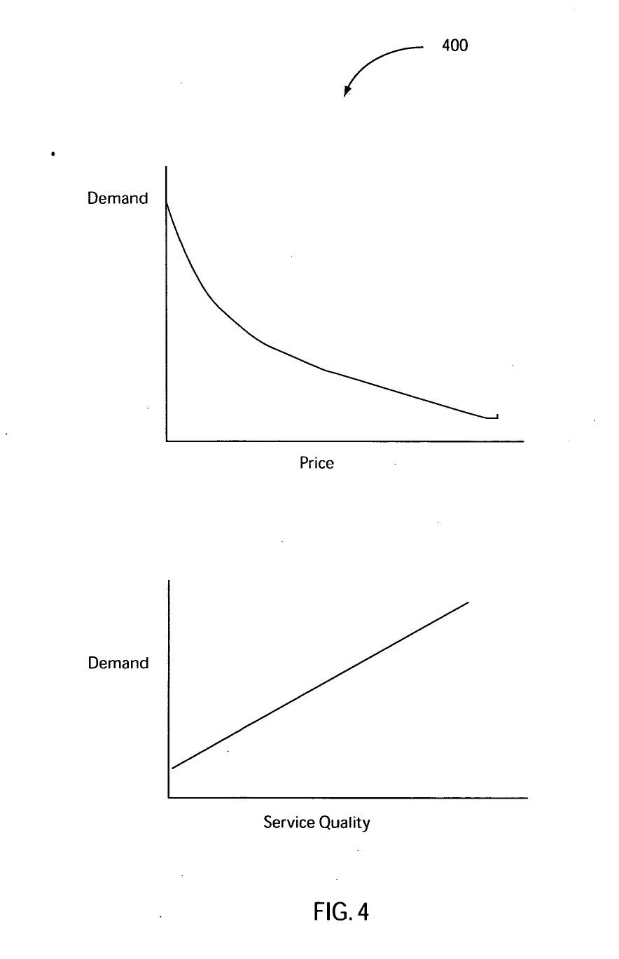

Turning to FIG. 4, a graph of one example demand model is indicated generally by the reference numeral 400. On the left side of FIG. 4 are the demand classes, j=1 . . . J for time periods 1 to N. The parameter tau(j,t) is the customer arrival rate of demand class j at the start of period t, and w(j) is the average workload per transaction in class j. On the right side of the figure are the service classes. The service usage rate, pi(k,s), represents the total workload of service class k at period s. This rate may be obtained, for example, by the following:
Pi(k,s)=ΣₜΣⱼtau(j,t) w(j) p(j,k,t,s),

where p(j,k,t,s) is the probability of a user in demand class j submitting a transaction at the start of period t choosing service class k at period s. Other methods may be used, however, to obtain the service usage rate in accordance with this invention.

Through a method such as the probabilistic method above, it is possible to model the probability of non-purchase.

Then, in one embodiment of the method, the probability that a user from demand class j submits a transaction at period t to service class k to be processed at period s is given by the multinomial logit function, or some other probabilistic or deterministic function.

If a probabilistic method is used in the embodiment of the invention, then some aspects of the invention are as follows: as transactions cannot be processed in a period earlier than they are submitted, the probability is zero when s<t. When s>t, U(j,k,t,s) is the dis-utility of a job from demand class j arriving at period t served in service class k at period s, and U(j0,t) is the dis-utility of a potential customer from class j processing its job through another service provider. Due to mis-information and other unmeasurable parameters involved in decision making, there is some randomness involved in customer choices; theta(j) in the range [0: infty) is the parameter characterizing the degree of randomness involved in class j customers' choices.

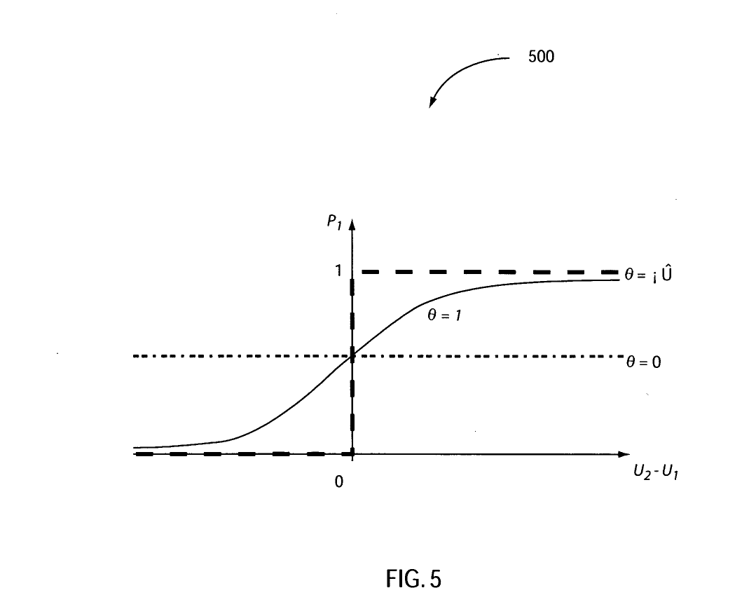

Turning to FIG. 5, a variation in the user choice probabilities as the degree of perfect information changes, as represented by parameter, theta, is also indicated generally by the reference numeral 500.

For example, in FIG. 5, by varying this logit scaling parameter, theta, we isolate three distinct cases for a model with two options, K=2.

For the first case, when theta=0, customer choices are totally random, and we can substitute the probability function with p_k=1/K for each choice k=1, . . . , K.

For the second case, when theta=infinity, customer choices are purely deterministic, as customers choose the option with the minimal dis-utility.

For the third case, when theta lies in the range (0: infinity), there is some error in the perception of the dis-utility of each choice, or some degree of randomness involved in customer choices. In this case, the logit function is differentiable, but non-linear.

A description will now be given regarding computing the capacity allocation, which is one possible embodiment of the invention.

Let phi(k,s) be the portion of computational capacity, c(s), used by class k at period s, and let mu be the service rate of one unit of computational capacity. Let T0 be the baseline sojourn time for a single workload unit, (note that the number of workload units per transaction varies across demand classes through w(j)), and let z(k,s)*T0 be the promised delay bound for a single workload unit in service class k. Due to the dynamic nature of computation service, there is some probability that an actual service time for one unit of workload in service class k at period s, T(k,s), exceeds the promised sojourn time. According to a result of queuing theory [Klein75], this probability has an upper bound denoted in the following:
P[Tₖ^{s}>zₖ^{s}T₀]≦e^{-(Φ}^{ₖ}^{^{s}}^{cμ-π}^{ₖ}^{^{s}}^{)z}^{ₖ}^{^{s}}^{T}^{₀}≐αₖ^{s}

We denote this upper bound by alpha(k,s).

$$◆ The equality is equivalent to , \\ {ϕ}_{k}^{s} = \frac{{π}_{k}^{s} - \frac{log {α}_{k}^{s}}{{z}_{k}^{s} {T}_{0}}}{c μ}$$

The sum of the processor sharing percentages, phi(s,k) must sum to no more than one for each time period, s.

$$◆ The system has to satisfy the natural capacity constraints on$$

$$the CPU perecentages , ϕ , \\ {\sum }_{k = 1}^{K} {ϕ}_{k}^{s} \leq 1 , for s = 1 , … , T .$$

Hence, the capacity required by class k at period s can be obtained from the optimal values of the decision variables, r* and z* as well as alpha(k,s).

A description will now be given regarding a mathematical formulation of the present invention in the context of a particular embodiment. Clearly other embodiments of the particular context and details are possible.

In this particular embodiment, we use the upper bound, alpha(k,s), to approximate the probability of delay in the objective function. This approximation is asymptotically correct when z(k,s)->infinity, if the service time distribution has a heavy tail. We presume that the service provider must pay a penalty of l(k) if the actual service time of a unit of workload in service class k at period s exceeds the promised sojourn time, T(k,s)>z(k,s)*T0, and the delay ratio is bounded from above by some tolerance level, z(k,s)<z′(k,s).

The formulation of the optimization problem is given as follows,

$${max}_{r , z} \qquad {\sum }_{t = 1}^{N} {\sum }_{s = t}^{N} {\sum }_{j = 1}^{J} {\sum }_{k = 1}^{K} {τ}_{j}^{t} {w}_{j} {p}_{jk}^{ts} ( r , z ) ( {r}_{k}^{s} - {l}_{k}^{s} {σ}_{k}^{s} ) .$$

$$\begin{matrix}s . t . & {\sum }_{k = 1}^{K} {ϕ}_{k}^{s} ( r , z ) \leq 1 , & for & s = 1 , … , N . & \\ & {ϕ}_{k}^{s} ( r , z ) , {r}_{k}^{s} \geq 0 , & for & k = 1 , … , K , & s = 1 , … , N . \\ & {z}_{k}^{s} \geq 1 , & for & k = 1 , … , K , & s = 1 , … , N .\end{matrix}$$

where r(k,s) and z(k,s) are the decision variables, l(k,s), alpha(k,s), z′(k,s), and w(j) are input parameters.

The functions p(t,s,j,k) (r,z) and phi(k,s) (r,z) are obtained from the formulae above.

A description will now be given of an exemplary implementation of the present invention.

Advantageously, the present invention allows for jointly determining the yield management prices and levels of service (SLA terms, for example, resource allocation) to offer to users/customers in multiple service classes over a time horizon of multiple time periods. For example, the time periods may be, but are not limited to, the 24 hours in each day. For each time period and each demand class, some portion is estimated to the desire service level in each service class at the present period or in some future period. Prices and service quality levels to offer within each service class are thus dependent upon this distribution of user preferences and the prices and quality-levels themselves.

In addition to providing the price points per service class and the proposed service levels to offer for at least one service class, for example, as part of an SLA, the present invention may provide the capacity which is required in each service class at each time period to ensure those levels and maximize provider revenue. The latter are the resource allocation/scheduling parameters. Due to the formulation provided herein, it is possible to obtain “stopping times” wherein the provider should change from one such configuration (price points/SLA terms/scheduling parameters) to another, so as to capitalize revenue. This number is typically much less than the number of periods into which the time horizon was divided. That means that the system need not be perturbed excessively by changes every period, while still ensuring a substantial increase in revenue beyond that which is obtainable without the present invention.

The invention may be implemented in many forms and in many applications, as readily determined by one of ordinary skill in this and related arts. For example, the present invention may be implemented as a “plug-in” to an on demand environment, such as one running an integration platform such as Websphere XD, which allows virtualization of resources, and hence sharing of resources across multiple applications, user types, service classes, and so forth. However, the present invention relies on a way to track and meter the usage of individual transactions for the calibration of the user demand parameters. It is presumed that such a means is available in an environment that uses the present invention.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. An apparatus for joint determination of price and resource allocation, comprising:
a price and resource allocation determination device for jointly determining a price and a resource allocation for a given item or service offered for use or sale by a given e-retailer to optimize a pre-specified objective for the given e-retailer.

2. The apparatus according to claim 1, wherein said price and resource allocation determination device determines ranges of prices and service levels for the given item or service so as to provide a plurality of combinations thereof, based upon at least one of demand data and resource usage data.

3. The apparatus according to claim 2, wherein said price and resource allocation determination device evaluates an expected profit for each of the plurality of combinations, and determines the price and resource allocation for the given item or service by determining a combination thereof that maximizes the expected profit for the given e-retailer.

4. The apparatus according to claim 1, wherein said price and resource allocation determination device determines the price and the resource allocation for the given item or service across multiple service classes.

5. The apparatus according to claim 1, wherein the service-level is based upon an expected transaction or job completion delay.

6. The apparatus according to claim 1, wherein said price and resource allocation determination device determines at least one price and at least one service level for each of a plurality of service classes, the plurality of service classes respectively corresponding to service-levels that are associated with a transaction or job involving the given item or service.

7. The apparatus according to claim 6, wherein said price and resource allocation determination device determines the at least one price and the at least one service level for each of the plurality of service classes further based on which time period of a plurality of time periods did the transaction or job commence for the given item or service.

8. The apparatus according to claim 1, wherein said price and resource allocation determination device determines stopping times at which parameters for at least one of the price and the resource allocation are reset to a different quantity.

9. A method for joint determination of price and resource allocation, comprising the step of:
jointly determining a price and a resource allocation for a given item or service offered for use or sale by a given e-retailer to optimize a pre-specified objective for the given e-retailer.

10. The method according to claim 9, further comprising the step of determining ranges of prices and service levels for the given item or service so as to provide a plurality of combinations thereof, based upon at least one of demand data and resource usage data.

11. The method according to claim 10, further comprising the steps of:
evaluating the expected profit for each of the plurality of combinations; and
determining the price and resource allocation for the given item or service by determining a combination thereof that maximizes the expected profit for the given e-retailer.

12. The method according to claim 9, wherein said determining step determines the price and the resource allocation for the given item or service across multiple service classes.

13. The method according to claim 9, wherein the service-level is based upon an expected transaction or job completion delay.

14. The method according to claim 9, wherein said determining step comprises the step of determining at least one price and at least one service level for each of a plurality of service classes, the plurality of service classes respectively corresponding to service-levels that are associated with the transaction or job involving the given item or service.

15. The method according to claim 14, wherein the at least one price and the at least one service level is determined for each of the plurality of service classes further based on which time period of a plurality of time periods did a transaction commence for the given item or service.

16. The method according to claim 9, further comprising the step of determining stopping times at which parameters for at least one of the price and the resource allocation are reset to a different quantity.

17. A computer program product comprising a computer usable medium including computer usable program code for joint determination of price and resource allocation, said computer program product including:
computer usable program code for jointly determining a price and a resource allocation for a given item or service offered for use or sale by a given e-retailer to optimize a pre-specified objective for the given re-retailer.

18. The computer program product according to claim 17, wherein said computer usable program code for jointly determining the price and the resource allocation comprises computer usable program code for determining ranges of prices and service levels for the given item or service so as to provide a plurality of combinations thereof, based upon at least one of demand data and resource usage data.

19. The computer program product according to claim 18, wherein said computer usable program code for jointly determining the price and the resource allocation further comprises:
computer usable program code for evaluating the expected profit for each of the plurality of combinations; and
computer usable program code for determining the price and resource allocation for the given item or service by determining a combination thereof that maximizes the expected profit for the given e-retailer.

20. The computer program product according to claim 17, wherein said computer usable program code for jointly determining the price and the resource allocation determines the price and the resource allocation for the given item or service across multiple service classes.

21. The computer program product according to claim 17, wherein the service-level is based upon an expected transaction or job completion delay.

22. The computer program product according to claim 17, wherein said computer usable program code for jointly determining the price and the resource allocation comprises computer usable program code for determining at least one price and at least one service level for each of a plurality of service classes, the plurality of service classes respectively corresponding to service-levels that are associated with the transaction or job involving the given item or service.

23. The computer program product according to claim 22, wherein the at least one price and the at least one service level is determined for each of the plurality of service classes further based on which time period of a plurality of time periods did a transaction commence for the given item or service.

24. The computer program product according to claim 17, further comprising computer usable program code for determining stopping times at which parameters for at least one of the price and the resource allocation are reset to a different quantity.
